(19) United States
(12) Patent Application Publication
(10) Pub. No.: US 2008/0137590 A1
(43) Pub. Date: Jun. 12, 2008

(54) DETACHABLE WIRELESS ADAPTER FOR VEHICLE COMMUNICATION MODULES

(75) Inventors: David Ian STOTT, Chadderton (GB); Simon Mark Thorley, South Lyon, MI (US)

Correspondence Address: MCDERMOTT WILL & EMERY LLP, 600 13TH STREET, N.W., WASHINGTON, DC, 20005-3096, US

(73) Assignee: IDSC Holdings LLC, Kenosha, WI (US)

(21) Appl. No.: 11/567,666

(22) Filed: Dec. 6, 2006

(51) Int. Cl. H04Q 7/00

(52) U.S. Cl. 370/328

(57) ABSTRACT

A wireless adapter for use with a vehicle communication module (VCM) for converting a signal received from a vehicle in a first signal protocol to a second signal in a second signal protocol. The VCM has a network connector dedicated to sending and receiving signals compliant to a local area network signal format in a wired manner. The adapter includes a VCM connector configured to detachably connect to the network connector of the VCM for receiving the signals compliant to the local area network signal format sent from the VCM. A data processor generates a wireless VCM signal based on the signals received from the VCM connector. A wireless transceiver is provided to establish a wireless link to a wireless data network. The wireless transceiver transmits the wireless VCM signal to the wireless data network, and receives a wireless host signal from the wireless data network. Information included in the received wireless host signal is processed to be compliant to the local area network signal format and conveyed to the VCM connector for transmitting to the VCM in a wired manner via the network connector of the VCM.

### FIELD OF DISCLOSURE

This application generally relates to interfacing between a vehicle communication module (VCM) and a host data processing system, such as a computer or PDA, in a wireless manner, and more specifically, to a wireless adapter configured to detachably connect to a connector on the VCM that is dedicated to receiving and transmitting signals compliant to a local area network format, such as Ethernet, for transmitting or receiving wireless signals, whereby the wireless communication does need to occupy a multi-function port, such as a USB port, and no software alteration on the VCM is needed to use the wireless adapter.

### BACKGROUND AND SUMMARY

Vehicle communication modules (VCMs) are used to provide a protocol translation between a first protocol used by an on-board vehicle diagnostic system or controllers of a vehicle, which may be one of many proprietary standards, and a second protocol used by a host data processing system, such as a PC or a PDA, such that data obtained from the on-board diagnostic system or controllers may be properly used and interpreted by the host data processing system, and vice versa, for proper diagnoses of the vehicle. Conventional VCMs often connect to the host data processing system in a wired manner, usually using a cable compliant to a specific communication standard, such as a 10BaseT wired Ethernet cable connected to the VCM's Ethernet connector. Some VCMs include one or more expansion or multi-function connectors for connecting to different peripheral devices or connectors with different functions. Examples of multi-function connectors include PCMCIA slots, USB connectors, etc. If needed, with appropriate alteration of software or installation of drivers on the VCM, these multi-function connectors can be used to connect to a wireless adapter to provide wireless communications to the VCMs.

However, the number of multi-function connectors on a VCM is not unlimited and therefore precious. Once a multi-function connector is occupied by the wireless adapter, the multi-function connector can no longer be used for function expansions or connecting to other peripheral devices. Furthermore, the software alteration or addition of drivers to the VCM requires additional data storage space on the VCM. Also, the finding and installation of appropriate software or drivers, or the needed changes of settings, requires special knowledge and familiarity of system and software operations, which garage technicians often do not possess.

Therefore, there is a need for providing a wireless communication link to a VCM without occupying multi-function connectors on the VCM. Additionally, there is a need for a wireless adapter that provides a wireless communication link to a VCM without the need to alter or add software on the VCM.

This disclosure describes various embodiments of wireless adapters that provide wireless communications to VCMs without occupying a multi-function connector, and without the need to alter or add software on the VCMs.

An exemplary wireless adapter is configured to use with a vehicle communication module (VCM) having a network connector dedicated to sending and receiving signals compliant to a local area network signal format in a wired manner. The network connector may be an Ethernet connector or any connector that is in compliant to other communication protocols or standards. The wireless adapter includes a VCM connector configured to detachably connect to the network connector of the VCM for receiving the signals compliant to the local area network signal format sent from the VCM. A processor is configured to generate a wireless VCM signal based on the signals received from the VCM connector. A wireless transceiver is provided to establish a wireless link to a wireless data network. The wireless transceiver transmits the wireless VCM signal to the wireless data network, and receives a wireless host signal from the wireless data network. Information embedded in the received wireless host signal is processed to be compliant to the local area network signal format and conveyed to the VCM connector for transmitting to the VCM in a wired manner via the network connector of the VCM. In one aspect, the VCM connector matches the network connector of the VCM.

In one embodiment, the wireless VCM signal and the wireless host signal are compliant to 802.11 standard. Signal packets compliant to the 802.11 standard are received and transmitted over 2.4 GHz spread spectrum radio. In one aspect, the processor demodulates the wireless host signal and converts the demodulated wireless host signal into the local area network format, such as 10Base-T or 100Base-T Ethernet packets or any other formats that can be used in transmitting data packets in a wired manner. In another aspect, the processor converts the signals received from the VCM, such as 10Base-T or 100Base-T Ethernet packets or any other formats that can be used in transmitting data packets in a wired manner, to wireless signals compliant to a wireless communication standard, such as 802.11, wireless LAN or any standards that define a wireless communication protocol.

The exemplary wireless adapter may be assigned a unique IP address. In one embodiment, the unique IP address assigned to the adapter is different from an IP address assigned to the VCM. In another embodiment, software updates may be sent to the adapter using the unique IP address assigned to the adapter.

This disclosure also describes a vehicle communication module that incorporates a wireless adapter described herein and a data processor configured to converts a first signal received from a vehicle complaint to a first signal protocol to a second signal compliant to a second signal protocol, for transmission to the wireless adapter. In one aspect, the data processor of the VCM converts the second signal to be compliant to the local area network format.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 is a block diagram illustrating the interconnections between a host data processing system, an exemplary wireless adapter, a VCM and a vehicle.

FIG. 2 is a more detailed schematic block diagram showing the connections between the vehicle, the VCM and the wireless adapter.

FIGS. 3A and 3B illustrate signal transactions between the wireless adapter, the host data processing system and the VCM during an initial communication utilizing address resolution protocol (ARP), to determine or assign IP address to each device.

FIGS. 4A and 4B illustrate the logical illustrations of the wireless adapter, the host data processing system and the VCM before and after their respective device ARP caches have been updated.

### DETAILED DESCRIPTION OF ILLUSTRATIVE EMBODIMENTS

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

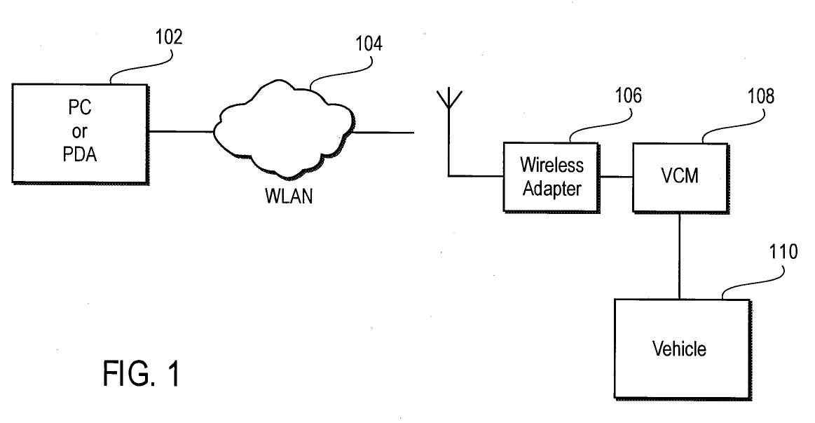

Embodiments of exemplary wireless adapters utilize VCM connector(s) that are conventionally dedicated to wired connection to a local area network, to establish wireless data communications for VCMs, without occupying multi-function connectors and without the need to change, alter or install software on the VCMs. FIG. 1 is a block diagram illustrating the interconnections between a host data processing system 102, an exemplary wireless adapter 106, a VCM 108 and a vehicle 110. The host data processing system 102 may be a computer, a PDA or any devices or apparatus capable of processing data. The wireless adapter 106 establishes a wireless communication link with a wireless data network, such as a local area network (WLAN), to transmit WLAN signals to, or receive WLAN signals from, the host data processing system 102. It is understood that other types of wireless communication standards also can be utilized to transmit signals between the wireless adapter 106 and the host data processing system 102.

The VCM 108 provides a protocol translation between a first protocol used by an on-board vehicle diagnostic system or controllers of the vehicle 110, which may be one of many proprietary standards, and a second protocol used by the host data processing system 102, such that data obtained from the on-board diagnostic system or controllers may be properly used and interpreted by the host data processing system 102, for proper diagnoses of the vehicle 110. Conversely, the VCM 108 converts data or signals are transmitted by the host data processing system 102 using the first protocol into the second protocol used by the vehicle 110, such that the transmitted data or signal can be properly understood and processed by the on-board vehicle diagnostic system or controllers of the vehicle 110.

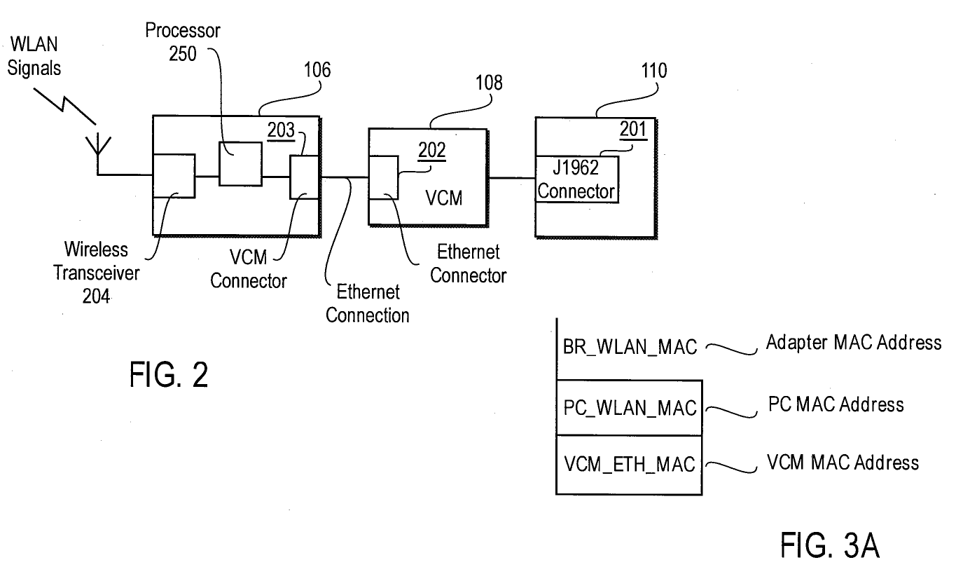

FIG. 2 is a more detailed schematic block diagram showing the connections between the vehicle 110, the VCM 108 and the wireless adapter 106. The VCM 108 connects to the vehicle via a connector 201, such as a J1962 connector, to receive and/or transmit signals. The VCM 108 has a network connector, such as an Ethernet connector 202, that is conventionally dedicated to establishing wired communications via a local area network like Ethernet via a Ethernet-compliant cable, such as a 10BaseT wired Ethernet cable.

The wireless adapter 106 includes a VCM connector 203 for coupling to the VCM 108. The VCM connector 203 may be matching the Ethernet connector 202 of the VCM 108, such that the VCM connector 203 connects to the Ethernet connector 202 of the VCM 108 directly. According to another embodiment, the VCM connector 203 connects to the Ethernet connector 202 of the VCM 108 via an Ethernet compliant cable, such as a 10BaseT wired Ethernet cable. A processor 250 of the wireless adapter 106 generates a wireless VCM signal, such as WLAN signals, based on the Ethernet signals received from the VCM connector 203, for transmission by a wireless transceiver 204; or conversely, generates an Ethernet signal based on the WLAN signals received from the wireless transceiver 204. In one embodiment, the WLAN signals are compliant to 802.11 standard. Signal packets compliant to the 802.11 standard are received and transmitted over 2.4 GHz spread spectrum radio. The processor 250 demodulates the received WLAN signals and converts the demodulated WLAN signals into the Ethernet-compliant format, such as 10Base-T or 100Base-T Ethernet packets or any other formats that can be used in transmitting data packets in a wired manner. In another aspect, the processor converts the Ethernet signals received from the VCM 108 to WLAN signals.

According to one embodiment, the processor 250 of the wireless adapter 106 includes a host processor and a wireless processor. The host processor manages interfaces with the Ethernet connection and the WLAN connection, executes firmware, responds to interrupts, controls access to the Ethernet, executes TCP/IP stack which handles IP address setup and packet buffering, and performs error correction. The host processor contains the hardware Ethernet media access control (MAC) address and a web server function to provide a basic web page configuration option and capture and store updated firmware. The wireless processor handles tasks related to modulation and demodulation, access to WLAN, error detection and correction, encryption and baseband signal generation.

The wireless adapter 106 utilizes layered OSI/TCP/IP protocol stack model. The model stipulates isolation between system components on different layers. Application software lies on the top layer (application layer), whilst adapter firmware and hardware lie on the lowest three layers. From the TCP/IP perspective, firmware executed on the VCM 108 and application/software executed on the vehicle 110 also lie on the application layer. According to one embodiment, the wireless adapter 106 has two functions within TCP/IP: (1) the wireless adapter 106 has its own IP address to which the wireless adapter 106 will respond when queried, and (2) the wireless adapter 106 also forwards packets sent to it from both its wired and WLAN interfaces to the other side. In one embodiment, the IP address assigned to the adapter 106 is different from an IP address assigned to the VCM 108. The adapter's IP address is provided for the purpose of configuration and firmware downloading. In one embodiment, a web server function resides at this IP address which allows a user to configure the wireless adapter 106 and send firmware update data to the wireless adapter 106. The wireless adapter performs no IP address translation on received packets, only MAC address translation.

The host processor may be implemented using a semiconductor chip NXP LPC2368, available from NXP of the Netherlands. Firmware that may be used to control the operation of the host processor is available from Cambridge Design Partnership of United Kingdom. The wireless processor may be implemented using Atmel AT76C515a ARM9 MAC/Modem controller with integral 802.11b/g, available from Atmel of San Jose, Calif. Firmware that may be used to control the wireless processor may be obtained from the same company.

With the exemplary configurations shown in FIGS. 1 and 2, the VCM 108 continues to use the Ethernet connector 202, conventionally dedicated to forming a wired connection to a local area network, to perform wireless communications via a wireless data network. Signals sent or received by the VCM 108 via the Ethernet connector 202 remain compliant to the Ethernet standard. As the transformation from WLAN signals into Ethernet signals, and the transformation from Ethernet signals into WLAN signals are performed by the wireless adapter 106, the wireless signal transformation is transparent to the VCM 108. The wireless adapter 106 creates a pipeline that allows the same transactions between the host data processing system 102 and the VCM 108 as in the wired case. No software alteration or addition is needed on the VCM 108.

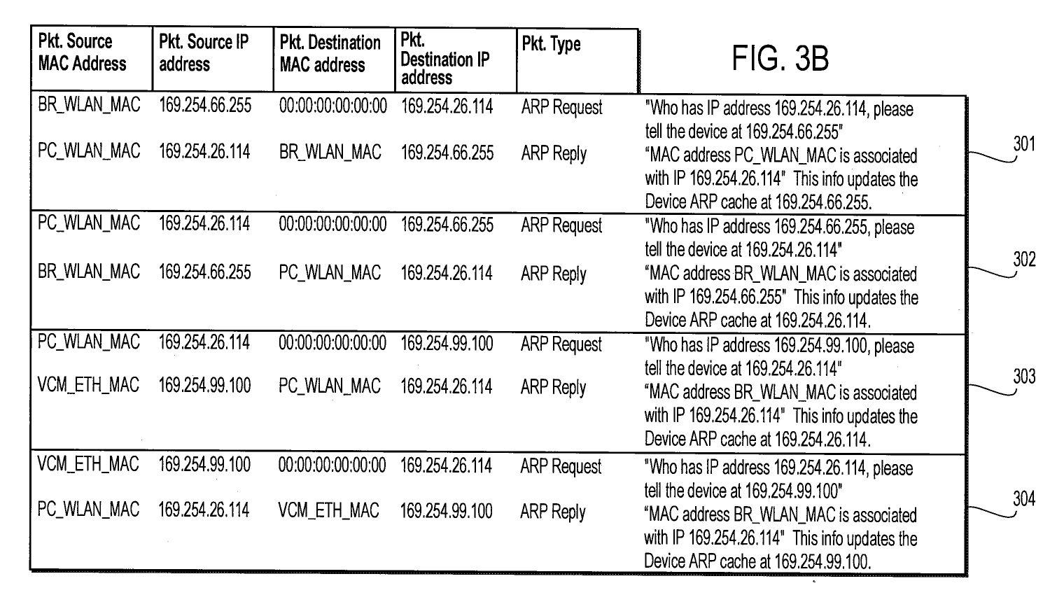

FIGS. 3A and 3B illustrate transactions between the wireless adapter 106, the host data processing system 102 and the VCM 108 during an initial communication utilizing address resolution protocol (ARP), to determine or assign IP address to each device. As shown in FIG. 3A, each one of the wireless adapter 106, the host data processing system 102 and the VCM 108 has a pre-assigned MAC address. The device resolve their own IP addresses by picking one and checking across the shared medium if any other connected device has chosen that IP. If no reply is forthcoming, the initially picked IP address is the chosen IP address for the device that issued the request.

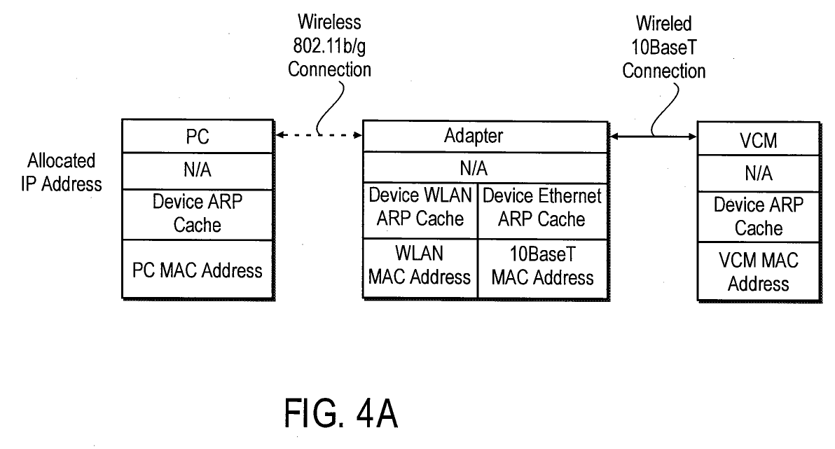

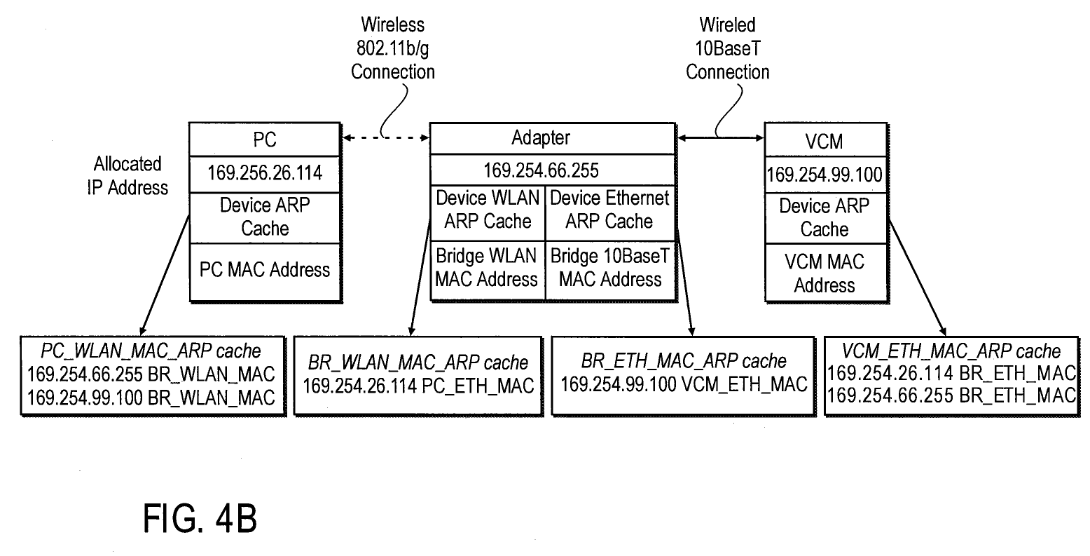

FIG. 4A shows the logical illustrations of the wireless adapter 106, the host data processing system 102 and the VCM 108 after their respective IP addresses have been chosen. After each of the devices receives data packets representing the chosen IP addresses, the three devices now need to update their respective ARP caches to associate the IP addresses with their respective MAC address.

As shown in Block 301 in FIG. 3B, the wireless adapter 106 has IP address 169.254.66.255 and broadcast an inquiry asking which device has the IP address 169.254.26.114, and requests that this information be reported to the device at 169.254.66.255. In response, the host data processing system 102 informs the wireless adapter 106 at 169.254.66.255 that the MAC address of the host data processing system 102 is associated with the IP address 169.254.26.114. This association info is stored in the Device ARP cache at 169.254.66.255.

In Blocks 302-304, inquiries and responses similar to those discussed in Block 301 are sent and received, and each respective Device ARP cache is updated. Similar steps are performed by each device having a MAC address. The result of the updates is shown in FIG. 4B.

After the association information between each MAC address and IP address has been performed, the wireless adapter 106 utilizes the association information in a bi-directional translation process between the Ethernet signals and WLAN signals. The wireless adapter 106 receives and transmits two types of frames, Ethernet and WLAN frames. The frames have different formats and the adapter's process is to translate between the two formats, in both directions. The frames are buffered within the device.

In processing an arriving Ethernet packet, Ethernet MAC Header included in the Ethernet packet is stripped off, and the WLAN MAC addresses (source and destination) are appended, and the resulting packet, with other proper transformation to form WLAN signals, is forwarded to the wireless transmitter 204 for transmission in WLAN format. Conversely, in processing an arriving WLAN packet, the wireless adapter 106 strips off the WLAN MAC Header included in the WLAN packet, and the Ethernet MAC addresses (source and destination) are appended to the Ethernet MAC header, and the resulting packet, with other proper transformation to form Ethernet signals, is forwarded on the Ethernet connector.

The exemplary wireless adapters and the connection configuration described in this disclosure are advantageous over conventional USB or PCMCIA-based wireless adapters in that no multi-function connectors are occupied and that no software alteration or installation is needed. Furthermore, the connection configuration more flexible over conventional point-to-point wireless transmitter-receiver setup because no specific pairing or pre-adjustment is needed. The exemplary adapters utilizes a TCP/IP architecture and ARP to set up dynamic configurations between devices.

The disclosure has been described with reference to specific embodiments thereof. It will, however, be evident that various modifications and changes may be made thereto without departing from the broader spirit and scope of the disclosure. The concepts described in the disclosure can apply to various operations of the networked presentation system without departing from the concepts. The specification and drawings are, accordingly, to be regarded in an illustrative rather than a restrictive sense.

What is claimed is:

1. A wireless adapter for use with a vehicle communication module (VCM) having a network connector dedicated to sending and receiving signals compliant to a local area network signal format in a wired manner, the adapter comprising:
a VCM connector configured to detachably connect to the network connector of the VCM for receiving the signals compliant to the local area network signal format sent from the VCM;
a processor configured to generate a wireless VCM signal based on the signals received from the VCM connector; and
a wireless transceiver configured to establish a wireless link to a wireless data network;
wherein:
the wireless transceiver transmits the wireless VCM signal to the wireless data network, and receives a wireless host signal from the wireless data network; and
information included in the received wireless host signal is processed to be compliant to the local area network signal format and conveyed to the VCM connector for transmitting to the VCM in a wired manner via the network connector of the VCM.

2. The adapter of claim 1, wherein the processor demodulates the wireless host signal and converts the demodulated wireless host signal into the local area network format.

3. The adapter of claim 2, wherein the local area network format is a 10Base-T or 100Base-T format.

4. The adapter of claim 1, wherein a unique IP address is assigned to the adapter.

5. The adapter of claim 4, wherein the unique IP address of the adapter is different from an IP address assigned to the VCM.

6. The adapter of claim 4, wherein software updates are sent to the adapter using the unique IP address assigned to the adapter.

7. The adapter of claim 1, wherein the processor generates the wireless VCM signal by converting the signals received from the VCM connector from the local area network signal format to a wireless local area network signal format.

8. A vehicle communication module including the wireless adapter of claim 1 and a data processor configured to convert a first signal received from a vehicle complaint to a first signal protocol to a second signal compliant to a second signal protocol, for transmission to the wireless adapter.

9. The vehicle communication module of claim 8, wherein the data processor converts the second signal to be compliant to the local area network format.

10. A wireless adapter for use with a vehicle communication module (VCM) having a network connector dedicated to sending and receiving signals compliant to a local area network signal format in a wired manner, the adapter comprising:
VCM connecting means for detachably connecting to the network connector of the VCM for receiving the signals compliant to the local area network signal format sent from the VCM;
data processing means for generating a wireless VCM signal based on the signals received from the VCM connecting means; and
wireless transceiver means for establishing a wireless link to a wireless data network;
wherein:
the wireless transceiver means transmits the wireless VCM signal to the wireless data network, and receives a wireless host signal from the wireless data network; and
information included in the received wireless host signal is processed to be compliant to the local area network signal format and conveyed to the VCM connecting means for transmitting to the VCM in a wired manner via the network connector of the VCM.

11. The adapter of claim 10, wherein the data processing means demodulates the wireless host signal and converts the demodulated wireless host signal into the local area network format.

12. The adapter of claim 11, wherein the local area network format is a 10Base-T or 100Base-T format.

13. The adapter of claim 10, wherein a unique IP address is assigned to the adapter.

14. The adapter of claim 13, wherein the unique IP address of the adapter is different from an IP address assigned to the VCM.

15. The adapter of claim 13, wherein software updates are sent to the adapter using the unique IP address assigned to the adapter.

16. The adapter of claim 10, wherein the data processing means generates the wireless VCM signal by converting the signals received from the VCM connector from the local area network signal format to a wireless local area network signal format.

17. A vehicle communication module including the wireless adapter of claim 10 and a data processing means for converting a first signal received from a vehicle complaint to a first signal protocol to a second signal compliant to a second signal protocol, for transmission to the wireless adapter.

18. The vehicle communication module of claim 17, wherein the data processing means converts the second signal to be compliant to the local area network format.
